(19) United States
(12) Patent Application Publication
(10) Pub. No.: US 2023/0259776 A1
(43) Pub. Date: Aug. 17, 2023

(54) METHOD AND APPARATUS FOR PERFORMING FILTER PRUNING ON CONVOLUTIONAL LAYERS IN NEURAL NETWORK

(71) Applicant: UIF (University Industry Foundation), Yonsei University, Seoul (KR)

(72) Inventors: Yoonsik CHOE, Seoul (KR); Taehyeon KIM, Seongnam-si (KR); Heungjun CHOI, Goyang-si (KR)

(21) Appl. No.: 18/089,355

(22) Filed: Dec. 27, 2022

(30) Foreign Application Priority Data
Jan. 14, 2022 (KR) 10-2022-0005931

(51) Int. Cl. G06N 3/082

(52) U.S. Cl. CPC G06N 3/082

(57) ABSTRACT

Provided is a method of pruning a plurality of convolutional layers in a target neural network. The method includes: acquiring the target neural network including the plurality of convolutional layers; setting a condition of an objective function on the basis of combinations of pruning rates respectively applied to the plurality of convolutional layers, wherein the condition is that the combination of pruning rates minimizing a value of the objective function minimizes a difference between filters of the plurality of convolutional layers and filters of the plurality of convolutional layers pruned by the combination of pruning rates minimizing the value of the objective function; and determining the combination of pruning rates minimizing the value of the objective function as a combination of optimal pruning rates from the objective function on the basis of Bayesian optimization.

### CROSS REFERENCE TO RELATED APPLICATION

The present application claims priority to Korean Patent Application No. 10-2022-0005931, filed Jan. 14, 2022, the entire contents of which is incorporated herein for all purposes by this reference.

### BACKGROUND OF THE INVENTION

### Field of the Invention

The present disclosure relates to a filter pruning method applicable in neural networks. More particularly, the present disclosure relates to a method of determining a combination of appropriate pruning rates to be applied to respective convolutional layers in a neural network.

### Description of the Related Art

Currently, deep learning is widely used in many technical fields such as image recognition, voice recognition, autonomous driving, and medical imaging. A convolutional neural network (CNN) is a representative network structure or algorithm in deep learning, and has achieved remarkable performance in various computer vision research applications such as image processing applications. However, the CNN requires a large model size and enormous computational cost, so it may be difficult to use the CNN in edge devices having limited computational resources and power budgets. Moreover, even state-of-the-art high-efficiency structures, such as residual connections or inception modules, have millions of parameters and require billions of float point operations (FLOPs). Therefore, it is necessary to develop a CNN having relatively low computational cost and high accuracy.

Recently, many studies have been carried out to improve CNN hardware efficiency by using various model compression strategies, such as pruning, tensor decomposition, quantization, and knowledge distillation. Among the aforementioned strategies, pruning is a strategy that has received attention in many previous studies because of effective performance and implementation.

The foregoing is intended merely to aid in the understanding of the background of the present disclosure, and is not intended to mean that the present disclosure falls within the purview of the related art that is already known to those skilled in the art.

### SUMMARY OF THE INVENTION

Recent studies on pruning fall into two categories: weight pruning and filter pruning. The filter pruning is intended to prune all unimportant filters. The basis task of the filter pruning method is to determine pruning policies that include pruning rates and pruning criteria. Determining a pruning rate appropriate for each layer is a crucial research point. However, many recent studies on pruning focus on measuring the importance of each filter. That is, most existing filter pruning methods specify pruning rates manually and use the same pruning rates for different layers. Therefore, a new filter pruning method that applies a pruning rate appropriate for each layer of a CNN model is required.

According to an embodiment of the present disclosure, there is provided a method of pruning a plurality of convolutional layers in a target neural network. The method includes: acquiring the target neural network including the plurality of convolutional layers; setting a condition of an objective function on the basis of combinations of pruning rates respectively applied to the plurality of convolutional layers, wherein the condition is that the combination of pruning rates minimizing a value of the objective function minimizes a difference between filters of the plurality of convolutional layers and filters of the plurality of convolutional layers pruned by the combination of pruning rates minimizing the value of the objective function; and determining the combination of pruning rates minimizing the value of the objective function as a combination of optimal pruning rates from the objective function on the basis of Bayesian optimization.

According to another embodiment of the present disclosure, there is provided an apparatus for pruning a plurality of convolutional layers in a target neural network. The apparatus includes: an acquisition unit configured to acquire the target neural network including the plurality of convolutional layers; a determination unit configured to set a condition of an objective function on the basis of combinations of pruning rates respectively applied to the plurality of convolutional layers, and determine the combination of pruning rates minimizing a value of the objective function as a combination of optimal pruning rates from the objective function on the basis of Bayesian optimization, wherein the condition is that the combination of pruning rates minimizing the value of the objective function minimizes a difference between filters of the plurality of convolutional layers and filters of the plurality of convolutional layers pruned by the combination of pruning rates minimizing the value of the objective function; and a pruning unit configured to prune the target neural network on the basis of the combination of optimal pruning rates of the plurality of convolutional layers.

### BRIEF DESCRIPTION OF THE DRAWINGS

The above and other objectives, features, and other advantages of the present disclosure will be more clearly understood from the following detailed description when taken in conjunction with the accompanying drawings, in which:

FIGS. 1A and 1B are diagrams illustrating a comparison between a conventional filter pruning method and an improved filter pruning method proposed in the present disclosure, according to an embodiment of the present disclosure;

FIG. 2 is a flowchart illustrating a method of pruning one or more filters corresponding to one or more convolutional layers in a CNN, according to an embodiment of the present disclosure;

FIG. 3 is a diagram illustrating the density of the remaining filters of each convolutional layer of a neural network after an HDBOFP method of the present disclosure is applied;

FIGS. 4A to 4E are diagrams illustrating object detection results according to an HDBOFP method of the present disclosure and a conventional filter pruning method; and

FIG. 5 is a diagram illustrating an apparatus for performing filter pruning on each convolutional layer in a neural network, according to embodiments of the present disclosure.

### DETAILED DESCRIPTION OF THE INVENTION

Hereinafter, embodiments of the present disclosure will be described in detail with reference to the accompanying drawings. Also, in describing the present disclosure, if it is decided that a detailed description of the known function or configuration related to the present disclosure makes the subject matter of the present disclosure unclear, the detailed description will be omitted. Further, the terms described below are defined in consideration of the functions in the embodiments of the present disclosure, which may vary depending on the intention of the user, the operator, or the custom. Therefore, the definition should be based on the contents throughout this specification. For the same reason, some elements may be exaggerated, omitted, or roughly illustrated in the accompanying drawings. In addition, the size of each element does not exactly correspond to the actual size. In each drawing, the same reference numeral is given to the same or corresponding element. Advantages and features of the technical idea according to the present disclosure, and methods to achieve them will be apparent from the following embodiments that will be described in detail with reference to the accompanying drawings. It should be understood that the present disclosure is not limited to the following embodiments and may be embodied in different ways, and that the embodiments are given to provide complete disclosure of the disclosure and to provide a thorough understanding of the present disclosure to those skilled in the art. The scope of the present disclosure is defined only by the claims. Throughout the description, the same reference numerals refer to same elements. In addition, in describing the present disclosure, if it is decided that a detailed description of the known function or configuration related to the present disclosure makes the subject matter of the technical idea of the present disclosure unclear, the detailed description will be omitted. Further, the terms described below are defined in consideration of the functions in the embodiments of the present disclosure, which may vary depending on the intention of the user, the operator, or the custom. Therefore, the definition should be based on the contents throughout this specification.

A convolutional neural network (CNN), which is one of representative algorithms of deep learning, is a feedforward neural network having a structure with a plurality of layers. The CNN may include one or more convolutional layers and one or more pooling layers corresponding thereto. A convolutional layer may be used to extract feature maps from input data. In general, the more convolutional layers there are, the more extracted feature maps there are, and it may be easy to generate more accurate output results.

Pruning is one of strategies developed to improve CNN hardware efficiency and may be broadly divided into two categories: weight pruning and filter pruning. Weight pruning aims to prune unnecessary elements individually from the weight(s) of one or more filters corresponding to one or more convolutional layers included in a CNN, and may achieve high model efficiency without loss of accuracy. However, weight pruning results in sparsity of irregular patterns, and requires special hardware to increase operation speed. Filter pruning aims to prune all unimportant filters among one or more filters corresponding to one or more convolutional layers. That is, the weight(s) of the filters pruned by filter pruning are regular, and may be directly accelerated using off-the-shelf hardware and libraries. Accordingly, the present disclosure is directed to providing an improved filter pruning method based on filter pruning, compared to a conventional filter pruning method.

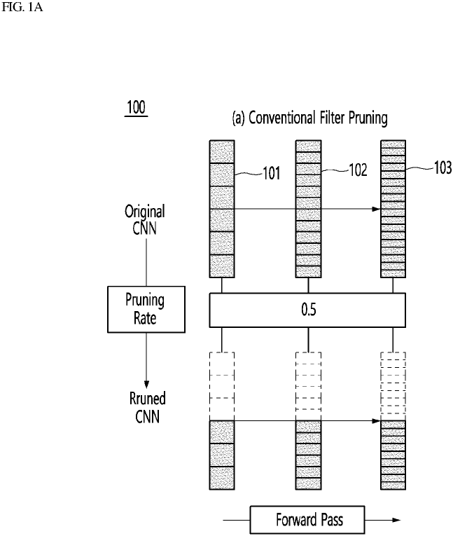

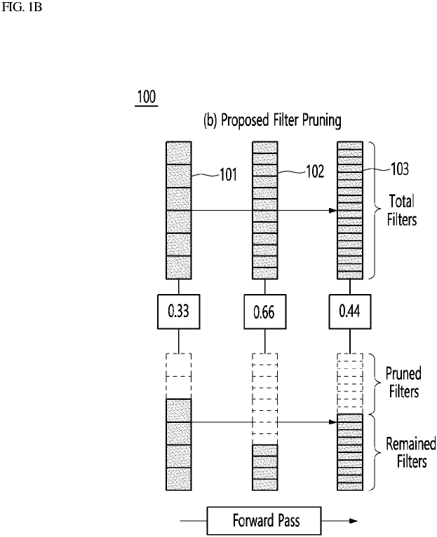

FIGS. 1A and 1B are diagrams illustrating a comparison between a conventional filter pruning method and an improved filter pruning method proposed in the present disclosure, according to an embodiment of the present disclosure. FIG. 1A shows a conventional filter pruning method, and FIG. 1B shows an improved filter pruning method proposed in the present disclosure.

Referring to FIGS. 1A and 1B, a first convolutional layer 101 of a CNN 100 includes six filters, a second convolutional layer 102 includes 12 filters, and a third convolutional layer 103 includes 18 filters. The conventional filter pruning method apply the same pruning rate to the different convolutional layers, and the pruning rate is manually specified. For example, in FIG. 1A, when the pruning rate is specified to 0.5, the pruning rate is applied to the first convolutional layer 101, the second convolutional layer 102, and the third convolutional layer 103, so that three filters of the first convolutional layer 101 are pruned, six filters of the second convolutional layer 102 are pruned, and nine filters of the third convolutional layer 103 are pruned. Conversely, the improved filter pruning method proposed in the present disclosure automatically determines a pruning rate appropriate for each convolutional layer according to a predetermined filter pruning method. For example, in FIG. 1B, when a pruning rate of 0.33 appropriate for the first convolutional layer 101 is determined and a pruning rate of 0.66 appropriate for the second convolutional layer 102 is determined and a pruning rate of 0.44 appropriate for the third convolutional layer 103 is determined, two filters of the first convolutional layer 101 are pruned and eight filters of the second convolutional layer 102 are pruned and eight filters of the third convolutional layer 103 are pruned. The predetermined filter pruning method of determining a pruning rate appropriate for each convolutional layer will be described in detail below.

With reference to FIGS. 1A and 1B, the description has made with the situation in which the number of convolutional layers included in each CNN is limited to three for convenience of description, but the number of convolutional layers is not limited thereto. For example, the embodiments of the present disclosure may be applied to convolutional layers of which the number is any number greater than three.

In order to provide an optimal pruning rate combination among combinations of pruning rates to be applied to the respective convolutional layers according to the predetermined filter pruning method according to the present disclosure, it is necessary to obtain information on accuracy degradation of all the combinations of pruning rates. However, measuring accuracy degradation is based on a time-consuming retraining step. Therefore, an efficient method capable of approximating accuracy degradation is required. The present disclosure proposes a new objective function that utilizes a soft filter pruning algorithm for measuring expected accuracy degradation with respect to a given combination of pruning rates. The objective function proposed in the present disclosure is based on the idea that a difference between a soft-pruned CNN and its original CNN is proportional to accuracy degradation of the pruned CNN. The objective function proposed in the present disclosure may measure expected accuracy degradation with respect to a given combination of pruning rates. In the meantime, obtaining an optimal pruning rate combination according to the objective function proposed in the present disclosure corresponds to a non-differentiable and non-convex optimization problem. To solve this problem, the present disclosure utilizes a Bayesian optimization method designed for black-box derivative-free global optimization. Furthermore, as the CNN deepens, that is, as the number of convolutional layers included in the CNN increases, a space of the objective function proposed in the present disclosure becomes a high-dimensional large-scale space, and this inevitably involves a trade-off between storage complexity, computational complexity, and accuracy. In general, standard Bayesian optimization becomes problematic in optimization as the dimension of the objective function increases. Therefore, the use of standard Bayesian optimization may be limited in applying the predetermined filter pruning method according to the present disclosure to a deep CNN having a large number of convolutional layers. To overcome this limitation, the predetermined filter pruning method according to the present disclosure utilizes a low-dimensional embedding-based Bayesian optimization, also called high-dimensional Bayesian optimization. In the meantime, the predetermined filter pruning method according to the present disclosure may be referred to as a high-dimensional Bayesian optimization-based filter pruning (HDBOFP) method.

As described above, unlike the conventional filter pruning method in which pruning rates to be applied to all convolutional layers are manually determined, the HDBOFP method of the present disclosure may automatically determine an effective pruning rate for each convolutional layer. The HDBOFP method of the present disclosure includes two major elements: (1) a newly proposed objective function to measure accuracy degradation with respect to a given combination of pruning rates, and (2) a high-dimensional Bayesian optimization providing a combination of optimal pruning rates with respect to the proposed objective function.

Hereinafter, the proposed objective function and the high-dimensional Bayesian optimization, which are the two major elements of the HDBOFP method of the present disclosure, will be described in more detail.

First, mathematical notation used in the present disclosure is defined as follows.

L: denotes the number of convolutional layers of a neural network (e.g., CNN).

K: denotes the filter (or kernel) size.

$${C}_{I}^{\left(l\right)} :$$

denotes the number of input channels of the lth convolutional layer.

$${C}_{O}^{\left(l\right)} :$$

denotes the number of output channels of the lth convolutional layer, that is, the number of filters of the lth convolutional layer.

$${\text{W}}_{i}^{\left(l\right)} ∈ {ℝ}^{K \times K \times {C}_{I}^{\left(l\right)}} \times {C}_{O} {}^{( l )}$$

: denotes the weight of the lth convolutional layer, that is, a filter (kernel) matrix based on the filters of the lth convolutional layer.

$${\text{W}}_{i}^{\left(l\right)} ∈ {ℝ}^{K \times K \times {C}_{I}^{\left(l\right)}} :$$

denotes the ith filter of the lth convolutional layer.

$$I ∈ {ℝ}^{{C}_{I}^{\left(i\right)} \times {H}_{I}^{\left(l\right)} \times {W}_{I}^{\left(l\right)}} \text{and} O ∈ {ℝ}^{{C}_{O}^{\left(l\right)} \times {H}_{O}^{\left(l\right)} {\times }_{O}^{\left(l\right)}} :$$

denote an input feature map and an output feature map of the lth convolutional layer, respectively, wherein W.^{(·)} and H.^{(·)}are the width and height of the feature maps, respectively.

p ∈ ℝ^{L}: denotes a combination of pruning rates of all convolutional layers of the neural network.

p⁽¹⁾ ∈ [0, 1 - ∈]: denotes the pruning rate of the lth convolutional layer, wherein ^{∈} is a very small number.

$${\tilde{W}}^{\left(l\right)} ∈ {ℝ}^{K \times K \times ( 1 - {p}^{( 1 - 1 )} {C}_{I}^{\left(l\right)} \times {C}_{O}^{\left(l\right)}} :$$

denotes the weight of the lth hard-pruned convolutional layer, wherein a hard-pruned convolutional layer means a result of applying hard filter pruning to a convolutional layer.

$${\overline{W}}^{\left(l\right)} ∈ {ℝ}^{K \times K \times {C}_{I}^{\left(l\right)} \times {C}_{O}^{\left(l\right)}} :$$

denotes the weight, which is the sparse tensor, of the lth soft-pruned convolutional layer, wherein a soft-pruned convolutional layer means a result of applying soft filter pruning to a convolutional layer. In the meantime, soft filter pruning zeroizes the filters selected to be pruned.

$$F = \left\{{\text{W}}_{i}^{\left(l\right)} , i ∈ \left[1 , {C}_{O}^{\left(l\right)}\right] , l ∈ \left[1 , L\right]\right\} :$$

denotes the filter set including all filters of the neural network.

$${F}^{⌣}$$

and

$$\overline{F} :$$

denote the filter set of the hard-pruned neural network and the filter set of the soft-pruned neural network, respectively.

In the meantime, filter pruning minimizes the value of the loss function under sparsity constraints on the filters. With respect to a given dataset

$$D = {\left\{\left({x}_{n} , {y}_{n}\right)\right\}}_{n = 1}^{N}$$

(wherein, xₙ denotes the nth input, and yₙ denotes the corresponding label), the constrained optimization problem for the loss function is shown in Formula 1.

$$\begin{matrix}\text{For} \frac{{C}_{M} \left({F}^{⌣}\right)}{{C}_{M} \left(F\right)} \leq {τ}_{M} \text{and} \frac{{C}_{F} \left({F}^{⌣}\right)}{{C}_{F} \left(F\right)} \leq {τ}_{F} , \\ {min}_{{F}^{⌣}} \frac{1}{N} {\sum }_{n = 1}^{N} \hat{L} \left({F}^{⌣} ; \left({x}_{n} , {y}_{n}\right)\right)\end{matrix} \qquad \text{<Formula 1>}$$

Herein,

$$\hat{L} ( ⋅ )$$

denotes a standard loss function (e.g., cross-entropy loss, mean squared error), and C_{M}(·) and C_{F}(·) denote the storage cost and the computational cost of the network, respectively. In addition, τ_{M} and τ_{F} denote the ratio between the storage costs of the pruned neural network and the original neural network, and the ratio between the computational costs of the pruned neural network and the original neural network, respectively.

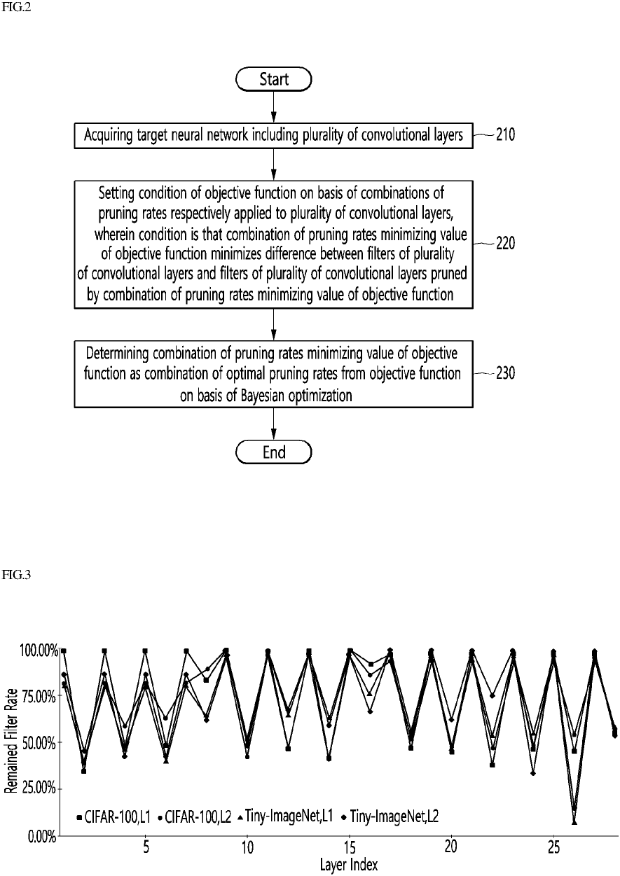

FIG. 2 is a flowchart illustrating a method of pruning one or more filters corresponding to one or more convolutional layers in a CNN, according to an embodiment of the present disclosure.

Referring to FIG. 2, in step 210, a target neural network including a plurality of convolutional layers is acquired. Each of the plurality of convolutional layers may include at least one filter.

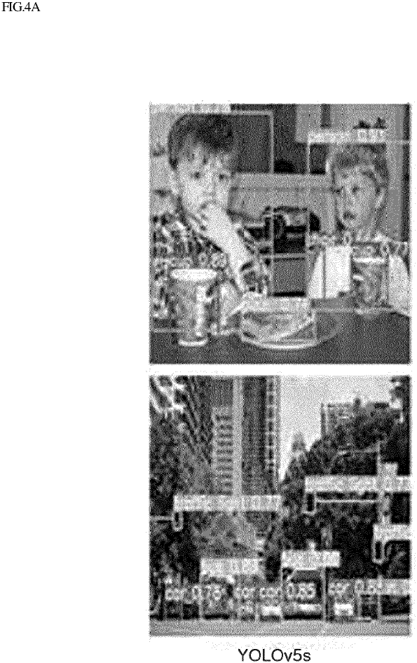

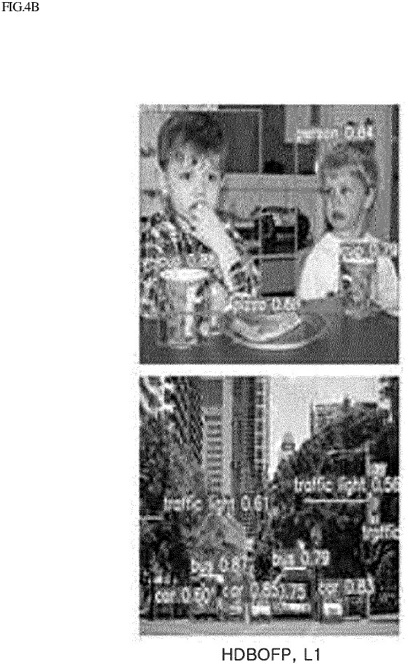

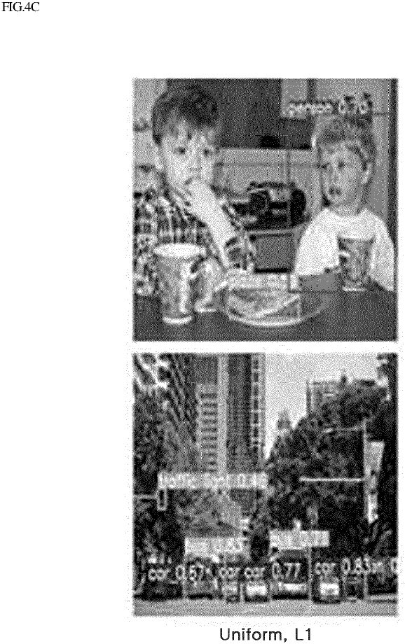

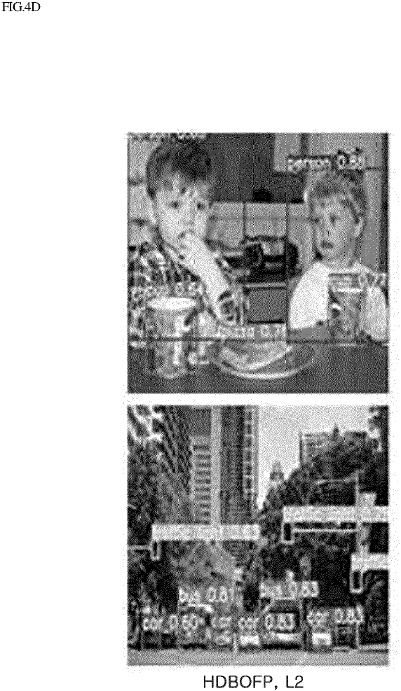

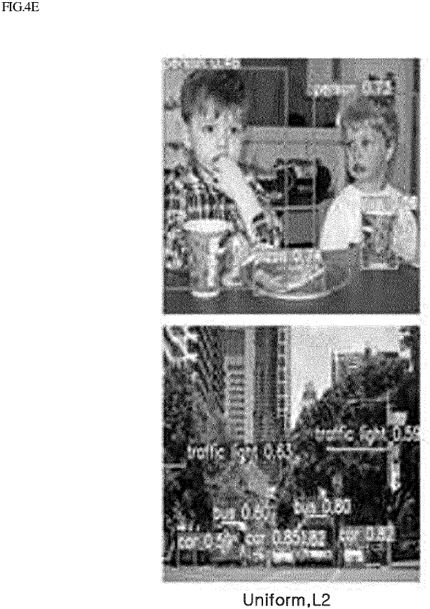

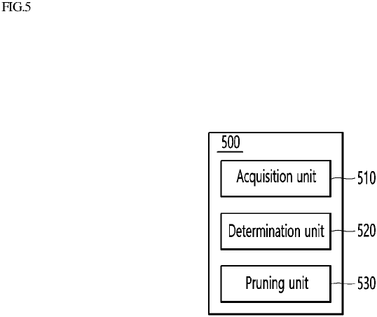

The target neural network may be a neural network obtained after training on a dataset of training samples. For example, the target neural network may be LeNet, AlexNet, VGGNet, GoogLeNet, ResNet, or other types of CNNs trained on CIFAR10, ImageNet, or other types of datasets. As another example, in the case of image classification (FIG. 3 and Table 1), the target neural network may be ResNet18 or ResNet34 trained on a CIFAR100 dataset. As still another example, in the case of image classification (FIG. 3 and Table 1), the target neural network may be ResNet18 or ResNet34 trained on a Tiny-ImageNet dataset. As still another example, in the case of object observation (FIGS. 4A to 4E and Table 2), the target neural network may be YOLOv5 trained on a MS-COCO dataset. As still another example, in the case of object observation (FIGS. 4A to 4E and Table 2), the target neural network may be YOLOv5 trained on a PASCAL-VOC dataset. In the meantime, although the embodiments of the present disclosure describe a CNN as an example of the target neural network for convenience of description, it can be understood that the HDBOFP method according to the embodiments of the present disclosure can be applied to any neural network including a convolutional layer.

According to an embodiment, the target neural network may further include a plurality of pooling layers respectively corresponding to the plurality of convolutional layers, at least one full connection layer, or other layers.

In step 220, on the basis of a combination of pruning rates respectively applied to the plurality of convolutional layers, a condition of an objective function is set.

Calculating accuracy degradation with respect to a given combination of pruning rates for the plurality of convolutional layers requires retraining the target neural network pruned with the given combination of pruning rates. However, this process consumes a lot of time, and the training process produces an output not identical to the target neural network. Accordingly, to solve this problem, the present disclosure expresses the objective function in the form of a loss function based on a combination of pruning rates to measure relative accuracy loss for the given combination of pruning rates without the retraining step, and the condition of the objective function is defined as in Formula 2.

For

$$\frac{{C}_{M} \left({F}^{⌣}\right)}{{C}_{M} \left(F\right)} \leq {τ}_{M}$$

and

$$\frac{{C}_{F} \left({F}^{⌣}\right)}{{C}_{F} \left(F\right)} \leq {τ}_{F} ,$$

$${min}_{\text{p}} L \left(\text{p;} F , {τ}_{M} , {τ}_{F}\right) = {min}_{\text{p}} \frac{1}{L} {\sum }_{l = 1}^{L} \frac{{\left‖{W}^{\left(l\right)} - {\overline{W}}^{\left(l\right)}\right‖}_{F}^{2}}{{\left‖{W}^{\left(l\right)}\right‖}_{F}^{2}} \qquad \text{<Formula 2>}$$

Herein, the loss function

$$L \left(\text{p;} F , {τ}_{M} , {τ}_{F}\right)$$

(or

$${}^{L ( p )} )$$

corresponds to the objective function, and ||·||_{F} denotes the Frobenius norm, which is defined as the square root of the sum of the squares of the absolute values of the elements.

That is, the condition of the objective function is a condition that a combination of pruning rates minimizing a value of the objective function minimizes a difference between the filters of the plurality of convolutional layers and the filters of the plurality of convolutional layers pruned by the combination of pruning rates minimizing the value of the objective function.

The main idea representing the objective function is that the relative accuracy loss is proportional to the reconstruction loss between the original filters and the soft-pruned filters. Therefore, the objective function may approximate the expected accuracy loss with respect to a given combination of pruning rates, and are not affected by the retraining process when searching for a combination of optimal pruning rates.

In the meantime, the objective function has the form of a constrained high-dimensional combination optimization that is a non-differentiable and non-convex optimization problem, so optimization problem can be solved using Bayesian optimization.

In step 230, a combination of pruning rates that minimizes the value of the objective function is determined as a combination of optimal pruning rates from the objective function on the basis of Bayesian optimization.

The Gaussian process may provide a posterior distribution that represents potential values of the objective function L(p) at an undiscovered pruning rate combination p. This may be based on the posterior distribution obtained from k previously observed pruning rate combinations p_{1:k} = {p₁, p₂, ..., pₖ}. That is, according to the Bayesian rule, the prior distribution.

$$L ( p )$$

$$L ( {p}_{1 : k} )$$

needs to be defined to obtain the conditional distribution

$$L ( p ) L ( {p}_{1 : k} ) .$$

$$L ( {p}_{1 : k} ) .$$

Therefore, the prior distribution.may be expressed as a multivariate normal distribution using the mean function µ₀ and the Mahalanobis kernel Σ₀, as shown in Formula 3.

$$L \left({\text{p}}_{1 : k}\right) \sim N \left({μ}_{0} \left({\text{p}}_{1 : k}\right) , {\sum }_{0} \left({\text{p}}_{1 : k} , {\text{p}}_{1 : k}\right)\right) \qquad \text{<Formula 3>}$$

Herein, .

$${μ}_{0} ( {p}_{1 : k} ) ∈ {ℝ}^{k}$$

denotes the mean vector,

$$\sum {}_{0} ( {p}_{1 : k} , {p}_{1 : k} ) ∈ {ℝ}^{k \times k}$$

denotes the Mahalanobis covariance matrix, and N(·,·) denotes a multivariate normal distribution function.

Using the prior distribution according to Formula 3, the conditional distribution of the objective function

$$L ( p )$$

may be calculated as shown in Formula 4.

$$\begin{matrix}L \left(\text{p}\right) \left|L \left({\text{p}}_{1 : k}\right) \sim N \left({μ}_{k} \left(\text{p}\right) , {σ}_{k}^{2} \left(\text{p}\right)\right) , {μ}_{k} \left(\text{p}\right)\right) \\ = {\sum }_{0} \left({\text{p, p}}_{1 : k}\right) {\sum }_{0} {\left({\text{p, p}}_{\text{1:k}}\right)}^{- 1} \left(L \left({\text{p}}_{1 : k}\right) - {μ}_{0} \left({\text{p}}_{1 : k}\right)\right) + {μ}_{0} \left({\text{p}}_{1 : k}\right) , {σ}_{k}^{2} \left(\text{p}\right) \\ = {\sum }_{0} \left(\text{p, p}\right) - {\sum }_{0} \left({\text{p, p}}_{1 : k}\right) {\sum }_{0} {\left({\text{p}}_{1 : k} , {\text{p}}_{1 : k}\right)}^{- 1} {\sum }_{0} \left({\text{p}}_{1 : k} , \text{p}\right)\end{matrix} \qquad \text{<Formula 4>}$$

Accordingly, using the conditional distribution, the potential values of the objective function for a pruning rate combination that has not been evaluated may be defined. This is generally associated with the distribution of k observed pruning rate combinations

$${p}_{k + 1} = \left\{{p}_{1} , {p}_{2} , ... , {p}_{k} \}\right) .$$

After the Gaussian process is performed, an expected improvement acquisition function may be utilized to determine the next pruning rate combination. The expected improvement acquisition function returns the (current) best pruning rate combination, that is, the combination that yields the lowest loss among the already observed pruning rate combinations. The objective function computes the loss of the observed pruning rate combination without noise, so the current best pruning rate combination ...

$${p}^{b e s t}$$

may be expressed as in Formula 5.

$${\text{p}}_{b e s t} = {arg min L \left({\text{p}}_{1 : k}\right)}_{{\text{p}}_{1 : k}} \qquad \text{<Formula 5>}$$

To quantify the improvement of a candidate pruning rate combination p, the expected improvement acquisition function compares the approximate objective error

$$L ( p )$$

of the candidate pruning rate combination with the loss value

$$L ( {p}_{b e s t} )$$

of the current best pruning rate combination. Thus, the expected improvement is defined as in Formula 6.

$${E}_{k} \left(p\right) : = {E}_{n} \left(max \left(L \left({\text{p}}_{b e s t}\right) - L \left(\text{p}\right) , 0\right)\right) \qquad \text{<Formula 6>}$$

Herein,

$${E}_{k} ( ⋅ ) = {E}_{k} ( ⋅ {\text{p}}_{1 : k )} L ( {\text{p}}_{1 : k} ) )$$

denotes the expectation of the posterior distribution for evaluations of

$$L$$

at a given

$${p}_{1 : k} .$$

The expected improvement acquisition function is primarily used because the expected improvement acquisition function has a closed form in the Gaussian processor.

To determine the next pruning rate combination

$${p}_{k + 1}$$

closer to the global optimal pruning rate combination p* than the current best pruning rate combination

$${p}^{b e s t} ,$$

the expected improvement acquisition function evaluates the candidate pruning rate combination p with the largest expected improvement as shown in Formula 7.

$${\text{p}}_{k + 1} = arg max {E}_{k} \left(\text{p}\right) \qquad \text{<Formula 7>}$$

After the expected improvement, when a Bayesian optimization termination condition is satisfied, the pruning rate combination

$${p}_{k + 1}$$

obtained from the expected improvement acquisition function is considered as the solution of the HDBOFP method of the present disclosure. When the Bayesian optimization termination condition is not satisfied, the obtained pruning rate combination

$${p}_{k + 1}$$

is used to construct the posterior distribution through the Gaussian process.

In the meantime, a conventional Bayesian optimization method is limited in terms of dimension. In particular, the Gaussian processor produces inaccurate prediction for dimensions larger than about 15 to 20. In the HDBOFP method of the present disclosure, the number L of convolutional layers corresponds to the dimension of the objective function. Therefore, using the conventional Bayesian optimization may propose applying the filter pruning method proposed in the present disclosure to filter pruning applications for a neural network (e.g., deep CNN) with L greater than 15 to 20. A common framework used to solve this problem is to consider a high-dimensional Bayesian optimization task as a conventional Bayesian optimization in low-dimensional embedding in which embedding may be linear or nonlinear. The HDBOFP method of the present disclosure utilizes linear embedding for high-dimensional Bayesian optimization.

When linear embedding is used for high-dimensional Bayesian optimization, it is assumed that there is a low-dimensional linear subspace including all variations in L : ℝ^{L} → ℝ. In particular, when Lₑ : ℝ^{e} → ℝ with e « L is defined for a low-dimensional linear subspace and T ∈ ℝ^{e×L} is defined as a projection from the L dimension to the e dimension, this linear embedding assumption satisfies Formula 8.

$$L \left(\text{p}\right) = {L}_{e} \left(\text{Tp}\right) \qquad \text{<Formula 8>}$$

A linear projection matrix T of the HDBOFP method of the present disclosure is generated by sampling L points from the hyper-sphere .

$${S}^{e - 1} .$$

To prevent distortion in the linear embedding, the HDBOFP method of the present disclosure constrains embedding optimization to points that are not projected outside the bounds, by changing Formula 7 to Formula 9.

For

$$- 1 \leq \text{T} † {\text{p}}_{e} \leq 1 , {max}_{{\text{p}}_{e} ∈ {ℝ}^{e}} {E}_{k} \left({\text{p}}_{e}\right) \qquad \text{<Formula 9>}$$

Herein, pₑ = Tp and T^{†} denotes the pseudo inverse matrix.

The constraints is Formula 9 are all linear. Thus, the constraints form a polytope, and the constraints may be solved using off-the-shelf optimization tools. Furthermore, the HDBOFP method of the present disclosure utilizes the Mahalanobis kernel in the Gaussian process. Thus, the projection is generally linear and may be effectively modeled within this constraint space. Consequently, the HDBOFP method of the present disclosure may be applied to deep neural network (e.g., deep CNN) pruning by using the above-described high-dimensional Bayesian optimization.

According to an embodiment, a combination of optimal pruning rates respectively corresponding to the plurality of convolutional layers of the target neural network may be obtained according to the HDBOFP method of the present disclosure, and filter pruning may be performed on the target neural network by applying the optimal pruning rates.

Hereinafter, the HDBOFP method of the present disclosure and the conventional filter pruning method will be compared in relation to image classification and object detection. The HDBOFP method of the present disclosure automatically provides a combination of pruning rates with respect to a given neural network (e.g., CNN) and filter pruning criteria. In the experiments below, L1-norm and L2-norm were selected as the filter pruning criteria. The L1-norm and the L2-norm are based on the assumption “less norm, less information”, and show superior performance in various computer vision applications. In addition, in the experiments, the HDBOFP method of the present disclosure set the desired FLOP reduction ratio τ_{F} and the desired memory compression ratio τ_{M}, like the conventional method in which the same pruning rate is applied to the convolutional layers. In addition, the embedding dimension e in high-dimensional Bayesian optimization was initialized to half the number L of convolutional layers of the neural network. After filter pruning according to each method, the pruned neural network was retrained to recover the performance of the pruned neural network. In the retraining step of the experiments, the pruned model (neural network) was trained for 30 epochs using a batch size of 256. In the experiments, retraining was performed three times, and “mean ± std” was reported.

Table 1 shows experimental results of comparing the HDBOFP method of the present disclosure with the conventional filter pruning method with respect to image classification. In Table 1, ResNet18 and ResNet34 were used as neural network models, and CIFAR100 and Tiny-ImageNet were used as datasets.

TABLE 1

| Dataset | Depth | Pruning Criteria | Pruning Rate | Acc. (%) | Acc.↓ (%) | FLOPs (%) | FLOPs↓ (%) | # of Param. (Mega) | # of Param.↓ (%) |
|---|---|---|---|---|---|---|---|---|---|
| CIFAR-100 | | BASELINE | | 76.38 | - | 0.42 | - | 2.78 | - |
| | 18 | L1 [3] | Uniform Ours | 75.00(±0.79) | 1.38 | 0.21 | 50.13 | 1.37 | 50.46 |
| | | | | 75.64(±0.16) | 0.74 | 0.2 | 52.48 | 0.97 | 65.02 |
| | | L2 [4] | Uniform Ours | 75.18(±0.72) | 1.2 | 0.21 | 50.13 | 1.37 | 50.46 |
| | | | | 76.11(±0.05) | 0.27 | 0.2 | 52.63 | 0.96 | 65.5 |
| | | BASELINE | | 76.91 | - | 1.01 | - | 1.82 | - |
| | 34 | L1 [3] | Uniform Ours | 73.92(±0.41) | 7.99 | 0.51 | 49.47 | 6.37 | 46.15 |
| | | | | 75.95(±0.15) | 0.96 | 0.5 | 50.19 | 6.12 | 48.27 |
| | | L2 [4] | Uniform Ours | 73.00(±1.37) | 3.38 | 0.51 | 49.47 | 6.37 | 46.15 |
| | | | | 78.65(±0.27) | 1.26 | 0.5 | 50.02 | 6.25 | 47.2 |
| Tiny-ImageNet | | BASELINE | | 45.26 | - | 1.69 | - | 2.78 | - |
| | 18 | L1 [3] | Uniform Ours | 43.66(±0.17) | 1.6 | 0.84 | 50.13 | 1.37 | 50.46 |
| | | | | 44.49(±0.23) | 0.82 | 0.82 | 51.12 | 1.31 | 52.85 |
| | | L2 [4] | Uniform Ours | 43.82(±0.19) | 1.44 | 0.84 | 50.13 | 1.37 | 50.46 |
| | | | | 44.44(±0.14) | 0.82 | 0.82 | 51.12 | 1.31 | 52.82 |
| | | BASELINE | | 49.77 | - | 4.04 | - | 11.82 | - |
| | 34 | L1 [3] | Uniform Ours | 47.81(±0.21) | 2.23 | 2.04 | 49.47 | 6.37 | 46.18 |
| | | | | 49.03(±0.32) | 0.74 | 2.02 | 50.14 | 6.24 | 47.26 |
| | | L2 [4] | Uniform Ours | 47.81(±0.25) | 1.96 | 2.04 | 49.47 | 6.37 | 46.15 |
| | | | | 48.68(±0.36) | 1.09 | 2.01 | 50.19 | 6.2 | 47.62 |

In Table 1, the expression “Acc.↓” denotes the accuracy degradation between the original neural network and the pruned neural network, and the smaller, the better. The expressions “FLOPs↓” and “# of Param.↓” denote the computational cost drop and the memory cost drop, respectively, and the larger, the better.

Referring to Table 1, the experimental results proved that the HDBOFP method of the present disclosure is more effective than the conventional filter pruning method. Specifically, in the case of L1-norm, with respect to ResNet18 and CIFAR100, the conventional filter pruning method obtained the accuracy degradation of 1.38% with the acceleration ratio (that is, computational cost drop) of 50.13% and the memory efficiency ratio (that is, memory cost drop) of 50.46%. However, with respect to ResNet18 and CIFAR100, the HDBOFP method of the present disclosure obtained the accuracy degradation of 0.74% with the acceleration ratio of 52.48% and the memory efficiency ratio (that is, memory cost drop) of 65.02%. In addition, in the case of L2-norm, with respect to ResNet18 and CIFAR100, the conventional filter pruning method obtained the accuracy degradation of 1.2%. However, the HDBOFP method of the present disclosure obtained the accuracy degradation of 0.27% using more effective computational and storage costs. With respect to ResNet34, results similar to those of ResNet18 were obtained. That is, the HDBOFP method of the present disclosure achieved higher neural network efficiency and lower accuracy degradation than the conventional filter pruning method. For example, in the case of L1-norm, with respect to ResNet34 and CIFAR100, the conventional filter pruning method obtained the accuracy degradation of 2.99% with the acceleration ratio of 49.47% and the memory efficiency ratio of 46.15%. However, with respect to ResNet34 and CIFAR100, the HDBOFP method of the present disclosure obtained the accuracy degradation of 0.96% with the acceleration ratio of 50.19% and the memory efficiency ratio of 48.27%.

The experimental results of ResNet18 and ResNet34 for Tiny-ImageNet also show that the HDBOFP method of the present disclosure achieved the accuracy degradation of 1% or less with higher memory and computational efficiency than the conventional filter pruning method. These experimental results are obtained because the HDBOFP method of the present disclosure adaptively selects a pruning rate appropriate for each convolutional layer considering the filter distribution of each of the plurality of convolutional layers.

FIG. 3 is a diagram illustrating the density of the remaining filters of each convolutional layer of a neural network after an HDBOFP method of the present disclosure is applied. In FIG. 3, ResNet was used as a neural network model, and CIFAR100 and Tiny-ImageNet were used as datasets.

Referring to FIG. 3, peaks and crests indicate that the HDBOFP method of the present disclosure automatically prunes a 3×3 convolutional layer with a large pruning rate because the 3×3 convolutional layer generally has significant redundancy; however, the HDBOFP method prunes more compact 1×1 convolution networks with lower sparsity. The HDBOFP method of the present disclosure may fully explore the optimization space and may allocate sparsity in an improved method.

Table 2 shows experimental results of comparing the HDBOFP method of the present disclosure with the conventional filter pruning method with respect to object detection. In Table 2, YOLOv5 was used as a neural network model, and MS-COCO and PASCAL-VOC were used as datasets. In Table 2, mean average precision (mAP) with intersection-over-unit (IOU) thresholds of 0.5 and 0.95 was used to evaluate object detection performance.

TABLE 2

| Dataset | Pruning Criteria | Pruning Rate | mAP5 (%) | mAP5↓ (%) | mAP.95 (%) | mAP.95↓ (%) | FLOPs (Giga) | FLOPs↓ (%) | # of Param. (Mega) | # of Param.↓ (%) |
|---|---|---|---|---|---|---|---|---|---|---|
| MS-COCO | BASELINE | | 54.87 | - | 35.26 | - | 5.48 | - | 4.21 | - |
| | L1 [3] | Uniform Ours | 44.58(±0.84) | 10.29 | 27.13(±0.73) | 8.13 | 2.66 | 51.45 | 1.96 | 53.44 |
| | | | 48.23(±0.23) | 6.64 | 28.44(±0.34) | 6.82 | 2.61 | 52.37 | 1.93 | 54.16 |
| | L2 [4] | Uniform Ours | 44.38(±1.07) | 10.49 | 26.87(±0.98) | 6.39 | 2.66 | 51.45 | 1.96 | 53.44 |
| | | | 48.57(±0.38) | 6.35 | 29.78(±0.28) | 5.48 | 2.6 | 52.55 | 1.93 | 54.16 |
| PASCAL-VOC | BASELINE | | 82.73 | - | 58.03 | - | 5.48 | - | 4.21 | - |
| | L1 [3] | Uniform Ours | 67.15(±0.26) | 15.58 | 39.67(±0.82) | 18.36 | 2.66 | 51.45 | 1.96 | 53.44 |
| | | | 77.38(±0.36) | 5.35 | 49.34(±0.22) | 8.69 | 2.6 | 52.55 | 1.94 | 53.91 |
| | L2 [4] | Uniform Ours | 59.64(±0.54) | 23.09 | 33.32(±0.53) | 24.71 | 2.66 | 51.45 | 1.96 | 53.44 |
| | | | 74.33(±0.37) | 8.4 | 46.13(±0.34) | 11.9 | 2.61 | 52.37 | 1.94 | 53.91 |

Referring to Table 2, in the case of L1-norm, with respect to YOLOv5 and MS-COCO, the conventional filter pruning method obtained the mAP.95 accuracy degradation of 8.13% with the acceleration ratio of 51.45% and the memory efficiency ratio of 53.44%. However, with respect to YOLOv5 and MS-COCO, the HDBOFP method of the present disclosure obtained the mAP.95 accuracy degradation of 6.82% with the acceleration ratio of 52.37% and the memory efficiency ratio of 54.16%. In addition, in the case of L2-norm, with respect to YOLOv5 and MS-COCO, the conventional filter pruning method obtained the mAP.95 accuracy degradation of 8.39%. However, with respect to YOLOv5 and MS-COCO, the HDBOFP method of the present disclosure obtained the mAP.95 accuracy degradation of 5.48% with more effective computational and storage costs. With respect to PASCAL-VOC, results similar to those of MS-COCO were obtained. That is, the HDBOFP method of the present disclosure achieved higher neural network efficiency and lower accuracy degradation than the conventional filter pruning method. For example, in the case of L1-norm, with respect to YOLOv5 and PASAL-VOC, the conventional filter pruning method obtained the mAP.5 accuracy degradation of 15.58% with the acceleration ratio of 51.45% and the memory efficiency ratio of 53.44%. However, with respect to YOLOv5 and PASAL-VOC, the HDBOFP method of the present disclosure obtained the mAP.5 accuracy degradation of 5.35% with the acceleration ratio of 52.55% and the memory efficiency ratio of 53.91%.

FIGS. 4A to 4E are diagrams illustrating object detection results according to an HDBOFP method of the present disclosure and a conventional filter pruning method. In FIGS. 4A to 4E, YOLOv5 was used as a neural network model. FIG. 4A shows the original neural network. FIG. 4B shows the neural network pruned by applying the HDBOFP method of the present disclosure with respect to L1-norm. FIG. 4C shows the neural network pruned by applying the conventional filter pruning method with respect to L1-norm. FIG. 4D shows the neural network pruned by applying the HDBOFP method of the present disclosure with respect to L2-norm. FIG. 4E shows the neural network pruned by applying the conventional filter pruning method with respect to L2-norm.

Referring to the upper row of FIGS. 4A to 4E, the original neural network model detected two people, two cups, and one piece of pizza (FIG. 4A)), the neural network pruned by applying the HDBOFP method of the present disclosure with respect to L1-norm and L2-norm detected two people, two cups, and one piece of pizza (FIGS. 4B and 4D) similarly to the original neural network, the neural network pruned by applying the conventional filter pruning method with respect to L1-norm did not detect one person and two cups (FIG. 4C), and the neural network pruned by applying the conventional filter pruning method with respect to L2-norm did not detect one cup. That is, the HDBOFP method of the present disclosure achieved higher model efficiency and lower performance degradation than the conventional filter pruning method. Similarly to the upper row, the lower row of FIGS. 4A to 4E show object detection results according to the HDBOFP method of the present disclosure and the conventional filter pruning method. It is found that the conventional filter pruning method showed poor object detection performance compared to the HDBOFP method of the present disclosure.

FIG. 5 is a diagram illustrating an apparatus for performing filter pruning on each convolutional layer in a neural network, according to embodiments of the present disclosure.

Referring to FIG. 5, an apparatus 500 for performing filter pruning on each convolutional layer in a neural network may include an acquisition unit 510, a determination unit 520, and a pruning unit 530. The acquisition unit 510 acquires a target neural network (e.g., CNN), the target neural network includes a plurality of convolutional layers, and each of the convolutional layers may include at least one filter. The determination unit 520 may set a new objective function according to an HDBOFP method of the present disclosure, and may determine a combination of pruning rates appropriate for the respective convolutional layers. The pruning unit 530 may prune the target neural network by applying the combination, which is determined by the determination unit 520, of the pruning rates appropriate for the respective convolutional layers to the target neural network. For a more detailed description of the apparatus 500, reference may be made to the above description of the method with FIGS. 1A to 4E and the apparatus 500 will not be described in detail herein.

According to an embodiment, the apparatus 500 may be implemented as at least one selected from the group of an application-specific integrated circuit (ASIC), a digital signal processor (DSP), a digital signal processing device (DSPD), a programmable logic device (PLD), a field programmable gate array (FPGA), a controller, a microcontroller, a microprocessor, or other electronic products. In addition, the examples of the apparatus are for illustrative purposes only. For example, unit division is only logical function division, and there may be other divisions in actual implementation. For example, several units or elements may be coupled or integrated into other systems, or some functions may be omitted or may not be implemented. In addition, mutual coupling, direct coupling, or communication connection illustrated or discussed may be indirect coupling or indirect communication connection through some interfaces, devices, or units of electrical or other forms. Units described as separate elements may be or may not be physically separated. Elements represented as units may be or may not be physical units, that is, may be located in one place or distributed over several network units.

According to other embodiments, the apparatus 500 may be implemented in the form of a software functional unit. When a functional unit is implemented in the form of a software functional unit and is sold or used as an independent product, the functional unit may be stored in a computer-readable storage media and may be executed by a computer device. Based on this understanding, essential elements of the technical solutions of the present disclosure, part of the present disclosure contributing to conventional technologies, or all or a part of the technical solutions may be implemented in the form of a software product and may be stored in a storage medium. The software product may include various commands that enable a computer device (e.g., a personal computer, a mobile terminal, a server, or a network device) to perform all or some steps of the methods of each embodiment of the present disclosure.

The embodiments of the present disclosure may also provide an electronic device including a processor and a storage device. The storage device may store therein a computer program executable by the processor. When the processor executes the computer program, the processor performs a method of determining a combination of pruning rates appropriate for respective convolutional layers in a neural network according to the above-described embodiment. According to an embodiment, the electronic device may be a mobile terminal, a personal computer, a tablet computer, a server, etc.

The embodiments of the present disclosure may also provide a non-transitory computer-readable storage medium. The non-transitory computer-readable medium may store a computer program therein. When a processor executes the computer program, a method of determining a combination of pruning rates appropriate for respective convolutional layers in a neural network may be performed according to the above-described embodiment. According to an embodiment, the non-transitory computer-readable medium may be flash memory, read-only memory (ROM), electrically programmable ROM, electrically erasable programmable ROM, a register, a hard disk, a removable disk, a CD-ROM, or any other types of non-transitory computer-readable storage media known in the art.

Although specific embodiments have been described in the detailed description of the present disclosure, various modifications and changes may be made thereto without departing from the scope of the present disclosure. Therefore, the scope of the present disclosure should not be defined as being limited to the embodiments, but should be defined by the appended claims and equivalents thereof.

What is claimed is:

1. A method of pruning a plurality of convolutional layers in a target neural network, the method comprising:
acquiring the target neural network comprising the plurality of convolutional layers;
setting a condition of an objective function on the basis of combinations of pruning rates respectively applied to the plurality of convolutional layers, wherein the condition is that the combination of pruning rates minimizing a value of the objective function minimizes a difference between filters of the plurality of convolutional layers and filters of the plurality of convolutional layers pruned by the combination of pruning rates minimizing the value of the objective function; and
determining the combination of pruning rates minimizing the value of the objective function as a combination of optimal pruning rates from the objective function on the basis of Bayesian optimization.

2. The method of claim 1, wherein the target neural network further comprises a plurality of pooling layers corresponding to the plurality of convolutional layers, and at least one full connection layer.

3. The method of claim 1, further comprising
pruning the target neural network on the basis of the combination of optimal pruning rates of the plurality of convolutional layers.

4. The method of claim 2, wherein the target neural network is a convolutional neural network.

5. The method of claim 1, wherein the determining of the combination of optimal pruning rates comprises
performing, when a dimension of the objective function is equal to or greater than a threshold value, projection on the objective function into a dimension less than the threshold value and applying the Bayesian optimization,
wherein all variations of the objective function are included in a linear subspace in a dimension less than the threshold value.

6. The method of claim 5, wherein the dimension of the objective function is determined on the basis of the number of the plurality of convolutional layers.

7. The method of claim 1, wherein the condition is defined as a formula below,
for
$$\frac{{C}_{M} {\left(F\right)}^{∨}}{{C}_{M} \left(F\right)} \leq {T}_{M}$$
and
$$\frac{{C}_{F} {\left(F\right)}^{∨}}{{C}_{F} \left(F\right)} \leq {τ}_{F} ,$$
$${min}_{\text{p}} L \left(\text{p;} F , {τ}_{M} , {τ}_{F}\right) = {min}_{\text{p}} \frac{1}{L} {\sum }_{l = 1}^{L} \frac{{\left‖{W}^{\left(l\right)} - {\overline{W}}^{\left(l\right)}\right‖}_{F}^{2}}{{\left‖{W}^{\left(l\right)}\right‖}_{F}^{2}}$$
wherein ^{P} denotes a combination of any pruning rates for the plurality of convolutional layers of the target neural network, ^{ℒ} denotes the objective function, L denotes the number W^{(l)} of the plurality of convolutional layers, denotes a weight of an 1th convolutional layer, W̅^{(l)} denotes a weight of an 1th convolutional layer soft-pruned by the P, ∥•∥_{F} denotes Frobenius norm, F denotes a filter set of all the filters of the target neural network, F̅ denotes a filter set of the filters hard-pruned by the ^{P}, C_{M} (*) and C_{F}(*) respectively denote a storage cost and a computational cost of the target neural network, and τ_{M} and τ_{F} respectively denote a storage cost ratio and a computational cost ratio between the target neural network pruned and the target neural network not pruned.

8. The method of claim 6, wherein the projection is defined as a formula below,
$$L \left(\text{p}\right) = {L}_{e} \left(\text{Tp}\right)$$
wherein, ^{P} denotes a combination of any pruning rates for the plurality of convolutional layers of the target neural network, .ℒ denotes the objective function, e denotes the dimension less than the threshold value, ℒₑ denotes the objective function subjected to projection into the dimension less than the threshold value, T denotes a linear projection matrix generated by sampling L points from a hyper-sphere
$${S}^{e - 1} ,$$
and the L denotes the number of the plurality of convolutional layers.

9. An apparatus for pruning a plurality of convolutional layers in a target neural network, the apparatus comprising:
an acquisition unit configured to acquire the target neural network comprising the plurality of convolutional layers;
a determination unit configured to set a condition of an objective function on the basis of combinations of pruning rates respectively applied to the plurality of convolutional layers, and determine the combination of pruning rates minimizing a value of the objective function as a combination of optimal pruning rates from the objective function on the basis of Bayesian optimization, wherein the condition is that the combination of pruning rates minimizing the value of the objective function minimizes a difference between filters of the plurality of convolutional layers and filters of the plurality of convolutional layers pruned by the combination of pruning rates minimizing the value of the objective function; and
a pruning unit configured to prune the target neural network on the basis of the combination of optimal pruning rates of the plurality of convolutional layers.

10. The apparatus of claim 9, wherein the target neural network further comprises a plurality of pooling layers corresponding to the plurality of convolutional layers, and at least one full connection layer.

11. The apparatus of claim 10, wherein the target neural network is a convolutional neural network.

12. The apparatus of claim 9, wherein the determination unit is configured to perform, when a dimension of the objective function is equal to or greater than a threshold value, projection on the objective function into a dimension less than the threshold value and apply the Bayesian optimization,
wherein all variations of the objective function are included in a linear subspace in a dimension less than the threshold value.

13. The apparatus of claim 12, wherein the dimension of the objective function is determined on the basis of the number of the plurality of convolutional layers.

14. The apparatus of claim 9, wherein the condition is defined as a formula below,
for
$$\frac{{C}_{M} {\left(F\right)}^{∨}}{{C}_{M} \left(F\right)} \leq {τ}_{M}$$
and
$$\frac{{C}_{F} {\left(F\right)}^{∨}}{{C}_{F} \left(F\right)} \leq {τ}_{F} ,$$
$${min}_{\text{p}} L \left(\text{p;} F , {τ}_{M} , {τ}_{F}\right) = {min}_{\text{p}} \frac{1}{L} {\sum }_{l = 1}^{L} \frac{{\left‖{W}^{\left(l\right)} - {\overline{W}}^{\left(l\right)}\right‖}_{F}^{2}}{{\left‖{W}^{\left(l\right)}\right‖}_{F}^{2}}$$
wherein P denotes a combination of any pruning rates for the plurality of convolutional layers of the target neural network, ℒ denotes the objective function, L denotes the number W^{(l)} of the plurality of convolutional layers, denotes a weight of an 1th convolutional layer, W̅^{(l)} denotes a weight of an 1th convolutional layer soft-pruned by the P, ∥·∥_{F} denotes Frobenius norm, F denotes a filter set of all the filters of the target neural network, F̅ denotes a filter set of the filters hard-pruned by the P, C_{M}(·) and C_{F}(·) respectively denote a storage cost and a computational cost of the target neural network, and τ_{M} and τ_{F} respectively denote a storage cost ratio and a computational cost ratio between the target neural network pruned and the target neural network not pruned.

15. The apparatus of claim 13, wherein the projection is defined as a formula below,
$$L \left(\text{p}\right) = {L}_{e} \left(\text{Tp}\right)$$
wherein, P denotes a combination of any pruning rates for the plurality of convolutional layers of the target neural network, ℒ denotes the objective function, e denotes the dimension less than the thre shold value, ℒₑ denotes the objective function subjected to projection into the dimension less than the threshold value, T denotes a linear projection matrix generated by sampling L points from a hyper-sphere S^{e-1}, and the L denotes the number of the plurality of convolutional layers.
